(19) United States
(12) Patent Application Publication
(10) Pub. No.: US 2008/0107000 A1
(43) Pub. Date: May 8, 2008

(54) Optical Information Recording Medium, and Method For Recording to Optical Information Recording Medium

(76) Inventors: Hideo Kusada, Osaka (JP); Noboru Yamada, Osaka (JP)

Correspondence Address: WENDEROTH, LIND & PONACK L.L.P., 2033 K. STREET, NW, SUITE 800, WASHINGTON, DC, 20006, US

(21) Appl. No.: 11/791,505

(22) PCT Filed: Nov. 9, 2005
(86) PCT No.: PCT/JP05/20533

§ 371 Date: May 24, 2007

(30) Foreign Application Priority Data
Nov. 26, 2004 (JP) 2004-342196

(51) Int. Cl. G11B 7/24

(52) U.S. Cl. 369/275.1

(57) ABSTRACT

An optical information recording medium comprises at least a substrate with a guide groove, a reflective layer, a recording layer whose optical characteristics change reversibly under irradiation with a laser beam, a protective layer, a resin layer, and a transparent substrate, in that order, wherein the protective layer and the resin layer are in contact, and the protective layer is composed of an oxide of zinc an main component.

### FIELD OF THE INVENTION

The present invention relates to an optical information recording medium with which information can be recorded, reproduced, and rewritten, using an optical means such as irradiation with a laser beam, and to a method for recording to an optical information recording medium.

### BACKGROUND INFORMATION

Opto-magnetic recording media, phase-change recording media, and the like are known as media that allow large quantities of information to be recorded, and to be reproduced and rewritten at high speed. During recording, reproduction, and rewriting, these optical information recording media utilize differences in the optical characteristics of a recording material that are produced by local irradiation with a laser beam. For instance, an opto-magnetic recording medium utilizes differences in the rotational angle of the polarization planes of reflected light that are produced by differences in magnetization states. A phase-change recording medium, on the other hand, utilizes the fact that the amount of reflected light with respect to light of a specific wavelength varies between a crystalline state and an amorphous state, and new information can be overwritten simultaneously with the erasure of recorded information by modulating the output power of the laser. An advantage is therefore that information signals can be rewritten at higher speed.

The layer structure of a conventional optical information recording medium (hereinafter referred to as “recording medium”) 200 is shown in FIG. 2, which is an example of a phase-change recording medium, which have become very popular as DVD-RAM having a capacity of 4.7 GB per side.

The recording medium 200 has a light-incident-side protective layer 102, a light-incident-side anti-diffusion layer 103, a recording layer 104, a reflection-side anti-diffusion layer 105, a reflection-side protective layer 106, a light absorption layer 107, and a reflective layer 108, in this order, on a transparent substrate 101. These layers are formed mainly by sputtering. Further, a resin layer 109, an adhesive layer 110, and an application substrate 111 are provided over the reflective layer 108.

When a material whose main component was ZnS (a material whose refractive index with respect to the wavelength of the laser beam was at least 2.0) was used for the light-incident-side protective layer, for example, the thickness of the protective layer had to be increased to about 130 nm to satisfy the required optical characteristics of the recording medium 200. A problem was therefore that it took longer to form the film, and this drove up the production cost. On the other hand, when a material whose main component was SiO₂ (a material whose refractive index with respect to the wavelength of the laser beam was no more than 2.0) was used, for example, the required optical characteristics of the recording medium 200 could be satisfied by reducing the thickness of the protective layer to 50 nm or less. However, this meant that the recording layer and the transparent substrate were closer together, so when repeated recording was performed, heat generated from the recording layer damaged the transparent substrate, and this adversely affected the quality of the recording signal.

In view of this, an optical information recording medium in which an aluminum oxide, silicon oxide, magnesium oxide, fluoride, or other such material is used as the main component of the light-incident-side protective layer has been proposed as a way to solve these problems (see Patent Document 1, for example).

Patent Document 1: Japanese Laid-Open Patent Application 2005-4950

### DISCLOSURE OF THE INVENTION

### Problems Which the Invention is Intended to Solve

However, if the thickness of the light-incident-side protective layer is reduced (to 50 nm or less, for example) in the above-mentioned conventional optical information recording medium, this tends to adversely affect the corrosion resistance of the recording medium, the long-term storage stability of the signal, and the repeated recording and reproduction characteristics.

Also, in recording and reproduction to and from this recording medium at an ordinary rotation speed (such as a linear velocity of 8 to 12 m/s), laser irradiation causes the recording layer to generate heat, and this heat is readily transferred to the resin layer. Consequently, if recording is repeated a few hundred times, the resin layer will be susceptible to heat damage, and this results in inferior signal quality.

### DISCLOSURE OF THE INVENTION

The present invention is an optical information recording medium, comprising at least a substrate, a reflective layer, a recording layer, a protective layer, a resin layer, and a transparent substrate, in that order, wherein the protective layer and the resin layer are in contact, and the protective layer is composed of an oxide of zinc an main component to solve a problem. The substrate, here, has a guide groove, and the recording layer is a layer whose optical characteristics change reversibly under irradiation with a laser beam.

### EFFECT OF THE INVENTION

According to the present invention, it can be to obtain an optical information recording medium which has good corrosion resistance and recording/reproduction characteristics.

### BRIEF DESCRIPTION OF THE DRAWINGS

FIG. 1 is a diagram showing layer constituent of an optical information recording medium in Embodiment of the present invention; and

FIG. 2 is a diagram showing layer constituent of an optical information recording medium of prior art.

### DESCRIPTION OF THE SIGN

001 substrate
002, 108 reflective layer
003, 107 light absorption layer
004, 106 reflection-side protective layer
005, 105 reflection-side anti-diffusion layer
006, 104 recording layer
007, 103 light-incident-side anti-diffusion layer
008, 102 light-incident-side protective layer
009, 109 resin layer
010, 110 adhesive layer
011, 101 transparent substrate
111 application substrate

### DESCRIPTION OF THE PREFERRED EMBODIMENTS

The optical information recording medium (hereinafter referred to as “recording medium”) pertaining to the present invention will now be described in detail.

### Embodiment 1

The recording medium has at least a substrate, a reflective layer, a recording layer, a light-incident-side protective layer, a resin layer, and a transparent substrate, in this order.

The substrate has a guide groove for guiding the laser beam, and the other layers are laminated over the substrate. The material may be PMMA or another such resin, or glass or the like. Also, grooves and lands may be alternately formed in the substrate. A substrate may also be used in which the ratio of width between the grooves and lands varies. There are no particular restrictions on the thickness of the substrate, but at least 0.1 mm and no more than 1.2 mm is preferable. If it is at least 0.1 mm thick it will be more resistant to heat damage during thin film formation, and if it is no thicker than 1.2 mm, the portability of the recording medium will be ensured.

The reflective layer is provided for the purpose of facilitating effective light absorption by the recording layer and heat diffusion by the recording medium. The layer material preferably contains silver, which is good at radiating heat away, and this reflective layer is preferably in contact with the above-mentioned substrate. Bringing a thin film of a reflective layer containing silver into contact with a substrate having a guide groove allows the groove shape to be transferred to the opposite side of the reflective layer from the substrate, without losing the groove shape of the substrate. Specifically, the next recording layer can be formed while leaving the groove shape unchanged. Therefore, it is easier to discern the bumpiness of the groove shape during laser beam irradiation. The thickness of the reflective layer may be at least 60 nm and less than 200 nm. A sufficient heat radiation effect can be achieved if the thickness is at least 60 nm, and the groove shape of the substrate can be accurately and easily transferred if the thickness is less than 200 nm.

When irradiated with a laser beam, the recording layer undergoes a phase change between states of different optical characteristics. The “optical characteristics” referred to here are reflectivity, refractive index, for example. This allows information to be recorded, etc. The layer material can include one whose main component is a chalcogenide-based material whose main component is tellurium or selenium, for example, a material whose main component is Te—Sb—Ge, Te—Sn—Ge, Te—Sb—Ge—Se, Te—Sn—Ge—Au, Ag—In—Sb—Te, In—Sb—Se, In—Te—Se or the like can be used. The thickness of the recording layer is preferably at least 5 nm and no more than 12 nm. A thickness of at least 5 nm will ensure good contrast, which is the difference between the reflectivity of the recording medium when the recording layer is in a crystalline state, and the reflectivity in an amorphous state. A thickness of less than 12 nm allows the thermal capacity of the recording layer to be kept low. Therefore, the phase transition to an amorphous state during recording is promoted, and sufficiently large recording marks can be ensured.

The function of the light-incident-side protective layer is to protect the recording layer, that is, to prevent the oxidation, evaporation, and deformation of the recording layer material. Also, since optical absorptivity of the recording medium and the reflectivity differential between the recorded portions and erased portions can be adjusted by adjusting the thickness of this layer, another function of this layer is to adjust the optical characteristics of the recording medium. The layer material contains at least zinc, and contains an oxide of zinc (ZnO) as its main component. This is because ZnO has a low refractive index and is a material suited to reducing the thickness of the light-incident-side protective layer. The term “main component” as used here means a material (component) contained in an amount of at least 50% in the light-incident-side protective layer. The refractive index of the light-incident-side protective layer is preferably at least 1.30 and no more than 2.00 with respect to the wavelength of the laser beam. It is relatively easy to obtain a material with a refractive index of at least 1.30. A refractive index of no more than 2.00 will ensure good contrast, which is the difference between the reflectivity of the recording medium when the recording layer is in a crystalline state, and the reflectivity in an amorphous state, and allows the product to be mass produced. The thickness of the light-incident-side protective layer may be between 5 and 50 nm. If the thickness is at least 5 nm, the recording layer and the resin layer will be far enough apart that the recording layer will not be heat damaged. If the thickness is no more than 50 nm, the film can be formed in a short enough time to ensure adequate mass productivity. The above-mentioned material of the light-incident-side protective layer may contain an oxide of silicon, and preferably contains SiO₂. This is because it lowers the refractive index of the light-incident-side protective layer.

The resin layer serves as a coating layer that flattens out the transition between the light-incident-side protective layer and the transparent substrate. It also serves to prevent light-incident-side protective layer from being deformed, etc., by an increase in temperature due to irradiation with a laser beam as a result of a thinner light-incident-side protective layer. Accordingly, the resin layer is designed to come into contact with the light-incident-side protective layer. A heat-resistance resin material is used as the layer material. This resin material is preferably one whose weight after being heated to at least 200° C. in an oxygen atmosphere is no more than one-half its weight before heating. This is because it prevents damage to the resin layer by heat generated in the recording layer during the recording of a signal, and reduces degradation of recording signal quality. The resin material is different from the material of the substrate or the adhesive layer (discussed below), and is specific terms is a solution obtained by mixing 56 parts acrylic UV-setting resin (C1-860 made by Dainippon Ink and Chemicals), 0.3 part phenone-based photopolymerization initiator (Irgacure A and B made by Ciba-Geigy), and 10 parts fluorine-based surface modifier (Defenser TR220K made by Dainippon Ink and Chemicals).

The role of the transparent substrate is to transmit the laser beam and protect the recording medium. Its material and structure can be the same as those of the above-mentioned substrate.

The above is the basic structure of the recording medium pertaining to the present invention, but the structure may further comprise the following layers.

For example, a light absorption layer, a reflection-side protective layer, and a reflection-side anti-diffusion layer may be provided, in this order, over the reflective layer, between the reflective layer and the recording layer. Furthermore, a light-incident-side anti-diffusion layer may be provided between the recording layer and the light-incident-side protective layer, and an adhesive layer may be provided between the resin layer and the transparent substrate.

The light absorption layer serves to correct any difference in light absorption between the crystalline and amorphous states of the recording layer. This allows distortion of the recorded marks to be corrected, and better overwrite characteristics to be obtained. The layer material can include one which is Ge, Sb, Te, Pb, Mo, Ta, Cr, Si, W or mixture thereof.

The reflection-side protective layer plays the same role as the light-incident-side protective layer. The layer material has ZnS as its main component and also contains silicon, and is preferably a material containing SiO₂. The thickness may be adjusted as needed so as to maximize the difference between the reflectivity Rc when the recording layer is in an amorphous state (where Rc>16%) and the reflectivity Ra in a crystalline state.

The reflection-side anti-diffusion layer is provided mainly for the purpose of preventing atomic diffusion between the reflection-side protective layer and the recording layer, and particularly when the protective layer contains sulfur or a sulfide, to prevent the diffusion of this sulfur or sulfide. The material of the layer can be a material whose main component is a nitride, an oxynitride, or a carbide. As a nitride, for example, GeN, CrN, SiN, AlN, NbN, MoN, FeN, TiN, ZrN or the like can be used, as an oxynitride, for example, GeON, CrON, SiON, AlON, NbON, MoON or the like can be used, and as a carbide, for example, CrC, SiC, AlC, TiC, TaC, ZrC or the like can be used.

The light-incident-side anti-diffusion layer is provided mainly for the purpose of preventing atomic diffusion between the light-incident-side protective layer and the recording layer. The layer material can be the same as that of the reflection-side anti-diffusion layer.

The role of the adhesive layer is to stick the resin layer and the transparent substrate together, and the layer material is a resin obtained by mixing an acrylate oligomer, an acrylate monomer, and a photopolymerization initiator.

The material of the resin layer is not limited to the above-mentioned materials. For example, it may have an acrylic acid ester compound as its main component, to which a compound having water repellency is added. For example, the compound having water repellency including alkyl trialkoxysilane, tetraalkoxysilane, fluoroalkyl-trimethoxysilane, and/or fluorosurfactant can be used with a solvent such as trimethylol propanetriacrylate, neopentylglycol diacrylate, p-ethyl dimethyl aminobenzoate, tricyclodecane-3.8-dimethyloldiacrylate, trimethylol propanetripropoxy triacrylate, dioxane glycol diacrylate, neopentylglycol diacrylate, tetrahydrofurfryl acrylate, or the like. It is preferably MEGAFAC F-142D, F-144D, F-150, F-171, F-177, F-183, DEFENSA TR-220K (made by Dainippon Ink and Chemicals) for fluorosurfactant.

### Embodiment 2

An example of the method for manufacturing the recording medium given in Embodiment 1 above will now be described.

The various layers are formed in the order discussed below. Unless otherwise specified, the layers are formed by RF sputtering.

First, the substrate is placed in the vacuum film formation chamber of a sputtering apparatus.

The reflective layer is formed by introducing argon gas into the vacuum film formation chamber and sputtering a target containing the material of the reflective layer in an argon gas atmosphere. At this time, the reflective layer is formed on the guide groove side.

The recording layer is formed by sputtering a target containing the material of the recording layer.

The light-incident-side protective layer is formed by sputtering a target containing the material of the light-incident-side protective layer, such as ZnO.

The resin layer is formed by spin coating the light-incident-side protective layer with the resin material described in Embodiment 1, then curing the coating by irradiating it with UV rays.

Finally, the transparent substrate is applied.

The methods for producing a light absorption layer, a reflection-side protective layer, a reflection-side anti-diffusion layer, a light-incident-side anti-diffusion layer, and an adhesive layer, when these are further provided, will now be described.

After the formation of the reflection layer, the light absorption layer is formed by sputtering a target containing the material of the light absorption layer in an argon gas atmosphere.

The reflection-side protective layer is formed by sputtering a target containing the material of the reflection-side protective layer in an argon gas atmosphere.

The reflection-side anti-diffusion layer is formed by introducing argon gas into a vacuum film formation chamber and sputtering a target containing the material of the reflection-side anti-diffusion layer in a mixed gas atmosphere comprising argon gas and nitrogen gas.

After the formation of the recording layer, the light-incident-side anti-diffusion layer is formed by sputtering a target containing the material of the light-incident-side anti-diffusion layer in an argon gas atmosphere.

The adhesive layer is formed by coating the inner peripheral side of the resin layer with the layer material, then placing a substrate over this, evenly spreading out the coating over the entire surface by spin coating, and irradiating with UV rays to cure the coating.

RF sputtering was used as the above-mentioned sputtering method, but the present invention is not limited to this. For instance, DC sputtering may be used, in which a target to which conductivity has been imparted by depleting oxygen is sputtered by a pulse DC method in an atmosphere comprising a mixture of argon gas and oxygen gas.

### Embodiment 3

An example of how signals are recorded, reproduced, and erased to and from the recording medium in Embodiment 1 above will now be described.

A recording and reproduction apparatus comprising at least an optical head having an objective lens and a semiconductor laser light source, a drive apparatus for guiding the laser beam to the irradiation position, a tracking and focusing controller for controlling the position in the tracking direction and in the direction perpendicular to the film surface, a laser drive apparatus for modulating the laser power, and a rotation controller for rotating the recording medium, is used to record, reproduce, and erase signals.

The recording and erasure of signals are performed by using the rotational controller to rotate the recording medium, and irradiate the recording medium with the laser beam focused into a microscopic spot. EFM modulation is used as the signal type. The power level of the laser beam is modulated between a power level that generates an amorphous state, in which part of the recording layer can be reversibly changed to its amorphous state, and a power level that generates a crystalline state, in which part of the recording layer can be reversibly changed to its crystalline state. This modulation forms recording marks or erased portions, and records, erases, or overwrites information. Here, the portion irradiated at the power level that generates an amorphous state is formed by a pulse train, which is known as a multipulse, but may instead be formed by a pulse that is not a multipulse.

It is preferable here if the rotational speed of the recording medium is a linear velocity of at least 18 m/s. This is because if the speed is at least 18 m/s, enough heat can be released to minimize damage to the resin layer. Also, the wavelength of the laser beam during recording may be at least 380 nm and no more than 700 nm. The numerical aperture of the lens may be at least 0.55 and no more than 0.9. At least 0.55 and no more than 0.7 is preferable in order to increase recording density.

Next, working examples will be given to describe the results of producing and evaluating various recording media 100 on the basis of the above embodiments.

### Working Example 1

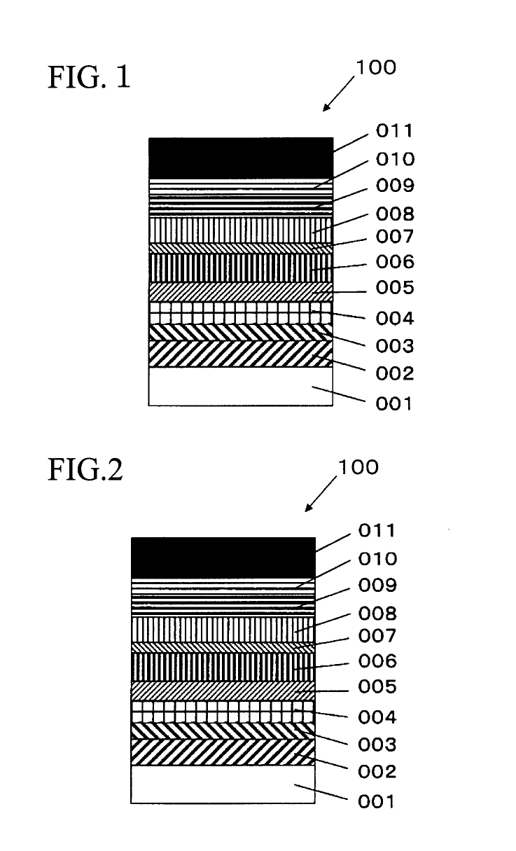

The structure of the recording medium in this working example will be described through reference to FIG. 1.

The recording medium 100 has a reflective layer 102, a light absorption layer 003, a reflection-side protective layer 004, a reflection-side anti-diffusion layer 005, a recording layer 006, a light-incident-side anti-diffusion layer 007, a light-incident-side protective layer 008, a resin layer 009, an adhesive layer 010 and a transparent substrates 001 on a substrate 001, in that order.

The substrate 001 was composed of a polycarbonate resin, had a thickness of 0.6 mm and a diameter of 120 mm, and had a guide groove. The substrate used here had lands and grooves formed alternately at a track pitch of 1.20 μm, that is, at every 0.60 μm.

The reflective layer 002 was formed in a thickness of 120 nm, using a Ag₉₈Pd₁Cu₁ (at %) alloy target.

The light absorption layer 003 was formed in a thickness of 30 nm, using a Si₆₆Cr₃₄ (at %) alloy target.

The reflection-side protective layer 004 was formed in a thickness of 24 nm, using a target containing 20 mol % SiO₂ in ZnO.

The reflection-side anti-diffusion layer 005 was formed in a thickness of 5 nm, using a Ge₈₀Cr₂₀ (at %) alloy target in a mixed gas atmosphere of argon gas and nitrogen gas, at a nitrogen partial pressure of 20%.

The recording layer 006 was formed in a thickness of 8 nm, using a Ge₃₈Sb₃Bi₅Te₅₄ (at %) alloy target.

The light-incident-side anti-diffusion layer 007 was formed in a thickness of 5 nm, using a Ge₈₀Cr₂₀ (at %) alloy target.

The light-incident-side protective layer 008 was formed in a thickness of 15 nm, using a ZnO target. The refractive index with respect to a laser beam wavelength of 650 nm was 1.89.

A resin layer 009 was formed in a thickness of 5 μm by coating a light-incident-side protective layer 008 by spin coating in a thickness of 20 μm with a resin material composed of the acrylic UV-setting resin or the like given as specific examples in Embodiment 1, and then irradiating this coating with UV rays to cure it.

An adhesive layer 010 was formed in a thickness of 25 μm from the layer material given in Embodiment 1.

Finally, a transparent substrate 011 with a thickness of 0.57 mm was applied.

### Working Example 2

A recording medium 100 was produced in the same manner as in Working Example 1, except that the thickness of the light-incident-side protective layer 008 was changed to 25 nm and the thickness of a reflection-side protective layer 004 was 20 nm.

### Working Example 3

A recording medium 100 was produced in the same manner as in Working Example 1, except that a target containing 30 mol % SiO₂ in ZnO was used, and the thickness of the light-incident-side protective layer 008 was changed to 15 nm.

### Working Example 4

A recording medium 100 was produced in the same manner as in Working Example 3, except that the thickness of the resin layer 009 was changed to 18 μm and the thickness of a adhesive layer 010 was 12 μm.

### Comparative Example 1

A recording medium 100 was produced in the same manner as in Working Example 1, except that the thickness of the light-incident-side protective layer 008 was changed to 3 nm and the thickness of a reflection-side protective layer 004 was 28 nm.

### Comparative Example 2

A recording medium 100 was produced in the same manner as in Working Example 1, except that a target containing 50 mol % SiO₂ in ZnO was used.

### Comparative Example 3

A recording medium 100 was produced in the same manner as in Working Example 1, except that a resin agent of an acrylic acid ester compound, for which the exothermic reaction temperature was 180° C., was used for the resin layer 009, and the thickness of the reflection-side protective layer 004 was changed to 24 nm.

### Comparative Example 4

A recording medium 100 was produced in the same manner as in Working Example 1. However, the rotation speed of the recording medium 100 in writing signals was slowed to a linear velocity of 12 m/s.

These recording media 100 were evaluated by the following methods.

The power level that generated an amorphous state, in which part of the recording layer 006 could be reversibly changed to its amorphous state by irradiation with a laser beam, was termed P1, and the power level that generated a crystalline state, in which part of the recording layer could be reversibly changed to its crystalline state by irradiation with a laser beam, was termed P2. The power level at which the optical state of recording marks was unaffected by irradiation with the laser beam, and the reflectivity was sufficient to reproduce the recording marks from the recording medium 100 was termed the reproduction power level P3. P3 was a lower power level than P1 and P2. A signal from the recording medium 100 obtained by irradiating with a laser beam of power level P3 was read by a detector, and the jitter value when the information signal was reproduced was measured. P1 and P2 were suitably adjusted to values at which the jitter value was at its bottom, and P3 was set at 1.0 mW. The values of P1 and P2 at which the jitter value was lowest were found for the grooves and lands, and the jitter change ΔJ, which is the difference between the jitter value J1 after 10 overwrites and the jitter value J2 after 1000 overwrites, was checked to be equal to J2−J1. ΔJ here is a reference indicating the recording and reproduction characteristics of the recording medium. ΔJ was evaluated to be good (∘) if less than 2%, fair (Δ) if at least 2% and less than 5%, and poor (X) if at least 5%.

The corrosion resistance of the recording medium was evaluated by checking for corrosion after 100 hours in an environment of 90° C. and 80% humidity. Corrosion resistance was evaluated to be good if no corrosion was found, fair if the corrosion was not enough to pose problems in the use of the recording medium 100, and poor if enough corrosion was found to impair the use of the recording medium 100.

The exothermic temperature of the resin layer was measured by TG-DTA method. More specifically, the resin layer was cured with UV rays to a specific thickness, then peeled away from the recording medium and finely crumbled to produce a sample. The temperature of this sample was raised at a rate of 0.4° C./second in an oxygen atmosphere. The temperature at which the weight of the sample here reached one-half the weight of the sample at room temperature was termed the exothermic temperature.

The sample was irradiated with a laser beam having a wavelength of 650 nm and at a numerical aperture of the objective lens of 0.6, and ΔR, which is the difference between the reflectivity Rc when the recording layer is in an amorphous state and the reflectivity Ra in a crystalline state, was measured.

Table 1 gives the evaluation results.

TABLE 1

| Light-Incident-Side | | | | | | | | | | |
|---|---|---|---|---|---|---|---|---|---|---|
| Protective Layer | | | Resin layer | | Linear | | | | | |
| Thickness | SiO₂ | | Thickness | Exothermic | Velocity | Δ R | P1 | P2 | Δ J | |
| (nm) | Amount | n | (μm) | Temp. (° C.) | (m/s) | (%) | (mW) | (mW) | (%) | Corrosion |

Example

| | | | | | | | | | | | |
|---|---|---|---|---|---|---|---|---|---|---|---|
| 1 | 15 | 0 | 1.89 | 5 | 300 | 20 | 14.0 | 16.5 | 7.0 | ◯ | ◯ |
| 2 | 25 | 0 | 1.89 | 5 | 300 | 20 | 12.5 | 17 | 7.5 | ◯ | ◯ |
| 3 | 15 | 30 | 1.77 | 5 | 300 | 20 | 14.5 | 16.2 | 6.8 | ◯ | ◯ |
| 4 | 15 | 30 | 1.77 | 18 | 300 | 20 | 14.4 | 16.2 | 6.8 | ◯ | ◯ |

Comparative Example

| | | | | | | | | | | | |
|---|---|---|---|---|---|---|---|---|---|---|---|
| 1 | 3 | 0 | 1.89 | 5 | 300 | 20 | 14.8 | 16.3 | 7.2 | Δ | Δ |
| 2 | 15 | 50 | 1.65 | 5 | 300 | 20 | 15.0 | 16.5 | 7.0 | ◯ | X |
| 3 | 15 | 0 | 1.89 | 5 | 180 | 20 | 14.0 | 16.5 | 7.0 | Δ | ◯ |
| 4 | 15 | 0 | 1.89 | 5 | 300 | 12 | 14.0 | 13.5 | 5.0 | Δ | ◯ |

In the results, with the recording media 100 of Working Examples 1 to 4 of the present invention, ΔJ was less than 2% in every case, and no corrosion was seen. Thus, it can be seen that optical information recording media with good recording and reproduction characteristics and corrosion resistance were obtained.

Meanwhile, with Comparative Example 1, neither ΔJ nor corrosion resistance was as good as in the working examples. A problem with corrosion resistance was encountered in Comparative Example 2. In Comparative Examples 3 and 4, ΔJ was not as good as in Working Example 1.

### INDUSTRIAL APPLICABILITY

The present invention makes it possible to provide an optical information recording medium with good recording and reproduction characteristics and corrosion resistance, and therefore can be applied to a variety of recording media.

1-9. (canceled)

10. An optical information recording medium, comprising at least a substrate with a guide groove, a reflective layer, a recording layer whose optical characteristics change reversibly under irradiation with a laser beam, a protective layer, a resin layer, and a transparent substrate, in that order,
wherein the protective layer and the resin layer are in contact, and
the protective layer is composed solely of an oxide of zinc, or solely of a compound whose main component is ZnO and to which an oxide of silicon has been added.

11. The optical information recording medium according to claim 10, wherein the substrate and the reflective layer are in contact.

12. The optical information recording medium according to claim 10, wherein the thickness of the protective layer is at least 5 nm and no more than 50 nm.

13. The optical information recording medium according to claim 10, wherein the refractive index of the protective layer with respect to the wavelength of the laser beam is at least 1.30 and no more than 2.00.

14. The optical information recording medium according to claim 10, wherein the weight of the resin layer after being heated to at least 200° C. in an oxygen atmosphere is no more than one-half its weight before heating.

15. A method for manufacturing an optical information recording medium comprising;
forming a reflective layer, a recording layer whose optical characteristics change reversibly under irradiation with a laser beam, a protective layer whose main component is an oxide of zinc, a resin layer that is in contact with the protective layer, and a transparent substrate, in that order, on a substrate having a guide groove.

16. A method for recording to the optical information recording medium having at least a substrate with a guide groove, a reflective layer, a recording layer whose optical characteristics change reversibly under irradiation with a laser beam, a protective layer, a resin layer, and a transparent substrate, in that order, wherein the protective layer and the resin layer are in contact, and the protective layer is composed solely of an oxide of zinc, or solely of a compound whose main component is ZnO and to which an oxide of silicon has been added; comprising;
irradiating the laser beam from the transparent substrate side, and
setting the linear velocity of the optical information recording medium during recording with respect to the laser beam at least 18 m/s.

17. The method for recording to an optical information recording medium according to claim 16, wherein the wavelength of the laser beam during recording is at least 380 nm and no more than 700 nm, and
the numerical aperture of a lens that emits the laser beam is at least 0.55 and no more than 0.90.
